(19) United States
(12) Patent Application Publication
(10) Pub. No.: US 2010/0250137 A1
(43) Pub. Date: Sep. 30, 2010

(54) Analytic Launch Collision Avoidance Methodology

(76) Inventor: Felix R. Hoots, Clifton, VA (US)

Correspondence Address: HENRICKS SLAVIN AND HOLMES LLP;SUITE 200, 840 APOLLO STREET, EL SEGUNDO, CA, 90245, US

(21) Appl. No.: 12/411,311

(22) Filed: Mar. 25, 2009

(51) Int. Cl. G06F 19/00; G06F 17/00

(52) U.S. Cl. 701/301

(57) ABSTRACT

An analytic launch collision avoidance method includes providing a launch collision avoidance report generated by evaluating launch times for a launch vehicle and candidate satellite crossing times for a plurality of satellites based on a geometric formulation in terms of two time variables.

### TECHNICAL FIELD

The invention relates generally to navigating an environment of resident space objects and, in particular, to a launch collision avoidance methodology in which safe launch times are determined using a completely analytic approach based on a geometric formulation in terms of two time variables.

### BACKGROUND ART

When a satellite is launched, it and the associated launch vehicle stages must pass through an environment of resident space objects. Depending on the final altitude of the new launch, its trajectory could potentially pass through the domain of thousands of resident satellites. Because the launch may occur any time during a launch window, it is a very complicated problem to distinguish safe launch times from unsafe launch times. The launch window span may range from a few minutes to a few hours. The planned launch usually follows a flight profile specified in an Earth fixed coordinate frame.

The process of launch collision avoidance conventionally involves comparing a flight profile with the positions of the resident satellite population for times throughout the launch window. In this way, time periods during the launch window are identified for which there is minimal risk of collision with any resident satellite. A selected launch trajectory should avoid any satellite close approach which creates an unacceptable level of risk, e.g., a probability of collision greater than some acceptable threshold.

Various approaches are currently in use to provide launch collision avoidance, typically, by comparing the launch trajectories of a launch vehicle (for numerous discrete launch times) to trajectories of the resident satellite population. By way of example, in a known approach, a launch window of some duration is divided into multiple discrete launch times spanning the window (either every minute or every second depending on the resolution required). For each discrete launch time, a straightforward brute force method steps along each satellite orbit to determine if any satellite “close approaches” occur. The commercially available software application STK/Conjunction Analysis Tools (STK/CAT), from Analytical Graphics, Inc. of Exton, Pa., performs launch collision avoidance and includes a close approach analysis feature. See, U.S. Pat. No. 6,102,334.

Unfortunately, conventional launch collision avoidance technologies are computationally intensive, as well as inefficient, and the demands upon them stand to (or may already) exceed their computational capabilities or timeline constraints as the satellite catalog and launch frequency grow.

It would be useful to be able to provide a launch collision avoidance technology capable of rapidly and efficiently determining safe launch times. It would also be useful to be able to provide a more sophisticated and efficient launch collision avoidance technology that avoids one or more of the deficiencies of prior solutions, such as reliance upon brute force computational approaches.

### SUMMARY OF THE INVENTION

Example embodiments described herein involve an analytic approach to the launch screening problem. Through a combination of geometry and dynamics considerations, the determination of launch window closure times is reduced to a relatively small set of discrete time pairs of launch and prediction times. These candidate times are refined with a Newton minimization using completely analytic partial derivatives. This methodology allows treatment of launch collision as a continuous function of time in contrast to current methods which can only provide answers for discrete fixed launch times. The launch collision avoidance methodology described herein is fast, efficient and accurate with a time savings approximately two orders of magnitude faster than current methods. Moreover, the launch collision avoidance methodology can enhance or augment conventional launch collision avoidance products making them more efficient and applicable to a broader problem set.

In an example embodiment, launch collision avoidance software is configured to search for the minimum value of the separation distance between the launch vehicle and the satellite, which is a function of the time of launch and the real world time. The search uses Newton's method for a function of two time variables. At the initial estimate, the gradient of the distance function is evaluated using analytical partial derivatives. These computations provide the data needed to compute corrections using Newton's method for both the launch time and the real world time. These corrections are applied to the initial estimate to provide an improved estimate for both the launch time and the real world time. Then the distance function at the new pair of times is evaluated. The new times are then used to repeat the whole process. The process continues until the corrections to both the launch time and the real world time are insignificant (fractions of a second). At this point, the iteration is declared to have converged resulting in a final estimate of the launch time and real world time. That is, they are the pair of times for which the launch vehicle and the satellite come closest together. The resulting distance is then assessed to determine whether the satellite is in danger of a collision.

In an example embodiment, an analytic launch collision avoidance method includes providing a launch collision avoidance report generated by evaluating launch times for a launch vehicle and candidate satellite crossing times for a plurality of satellites based on a geometric formulation in terms of two time variables.

In an example embodiment, an analytic launch collision avoidance method includes evaluating launch times for a launch vehicle and candidate satellite crossing times for a plurality of satellites using completely analytic partial derivatives to determine unsafe launch times, and initiating or canceling a launch event depending upon the unsafe launch times.

### BRIEF DESCRIPTION OF THE DRAWINGS

FIG. 1 is a graphical depiction of launch window inertial planes;

FIG. 2 is a graphical depiction of launch plane angles;

FIG. 3 is a graphical depiction of satellite plane intersection angles;

FIG. 4 is a graphical depiction of a launch vulnerability band;

FIG. 5 illustrates a launch collision avoidance methodology in operation;

FIG. 6 is a process flow illustrating data preprocessing steps in an example launch collision avoidance methodology;

FIG. 7 is a process flow illustrating main processing steps in an example launch collision avoidance methodology; and

FIG. 8 illustrates the standard deviation of the launch plane.

### DISCLOSURE OF INVENTION

Let the launch window be described by

Tₛₜₐᵣₜ=launch window start time(real world time)

T_{end}=launch window end time(real world time)

where the convention is introduced that an upper case T will be used for time as measured in the real world (year, day, hour, min, sec) and a lower case t will be used for time measured relative to some fixed real world event time such as element set epoch, launch window start time, etc.

The launch ephemeris is described by a time ordered set of positions and velocities of the launch vehicle expressed in Earth Centered Fixed (ECF) coordinates. Herein, it is assumed that the launch ephemeris begins on the surface of the Earth and terminates somewhere along the final desired orbit of the satellite. This termination may be the injection point or may be some number of minutes, say 100, beyond the injection point. By extending the ephemeris beyond the injection point, this assures not only a safe passage to orbit, but at least a safe first revolution through the satellite orbit. For satellites launched to a geosynchronous orbit, there may be slightly different ECF ephemeris files throughout the launch window because of a requirement for satellite placement at a specific longitude.

In example embodiments described herein, the launch collision avoidance methodology is configured (or programmed) to find all clear times within the launch window for which the launch trajectory (or trajectories) will not come closer than a specified threshold, D, to any resident satellite. It should be further understood that the principles described herein are also applicable to other space objects such as debris.

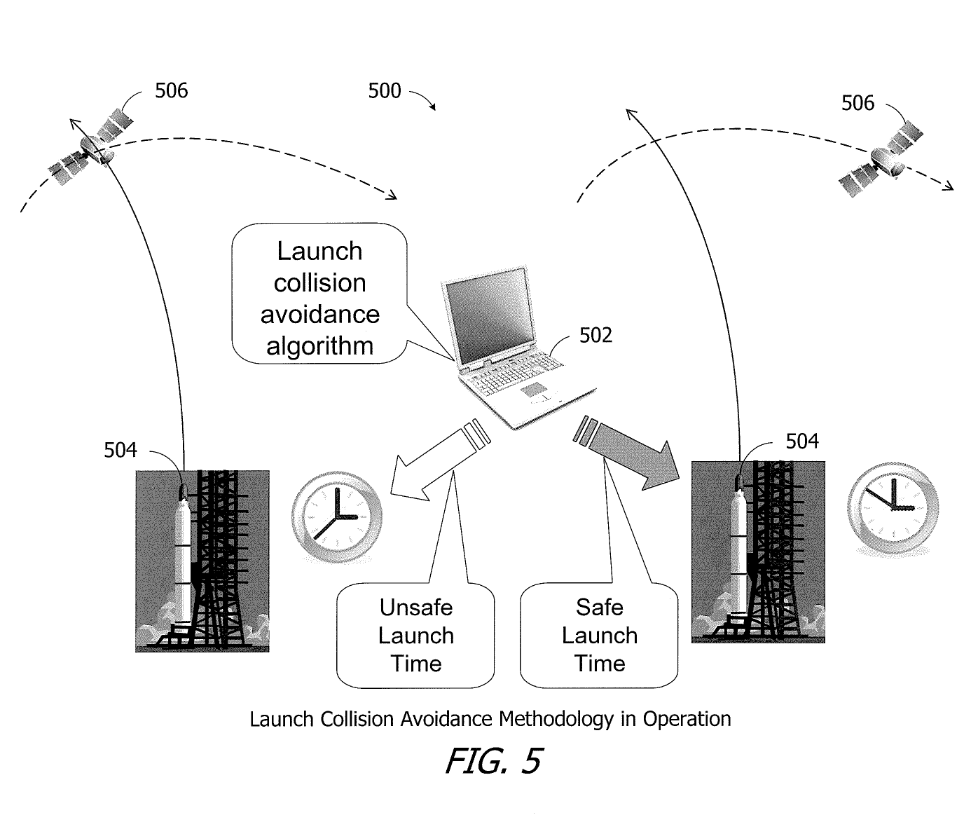

FIG. 5 illustrates the launch collision avoidance methodology in operation. In an operating environment 500, launch collision avoidance software (including launch collision avoidance algorithms) is executed by a computer 502 (including a processor) to generate launch collision avoidance reports, indications, commands and other inputs, signals or the like that can be used to make decisions regarding and control launch events. As illustrated in the left half of the figure, the launch collision avoidance software has determined that a proposed launch time for launch vehicle 504 is unsafe because of an unacceptably high probability of a collision with satellite 506. As also illustrated in the right half of the figure, the launch collision avoidance software has determined that a slightly later launch time for launch vehicle 504 is safe because of an acceptably low probability of a collision with satellite 506.

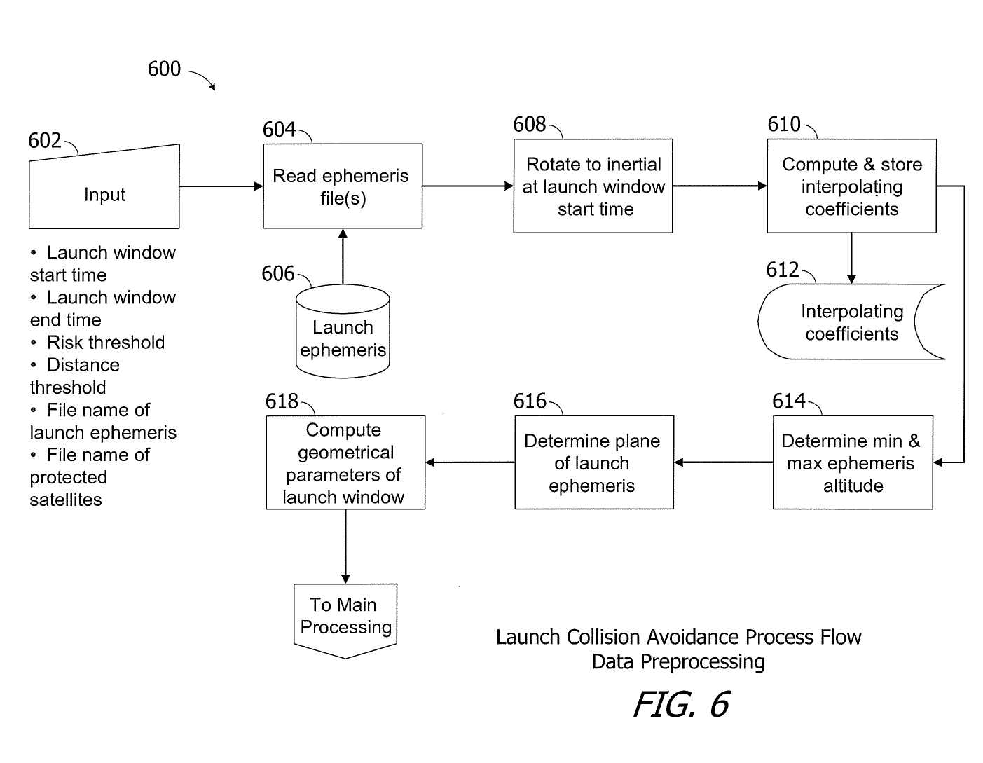

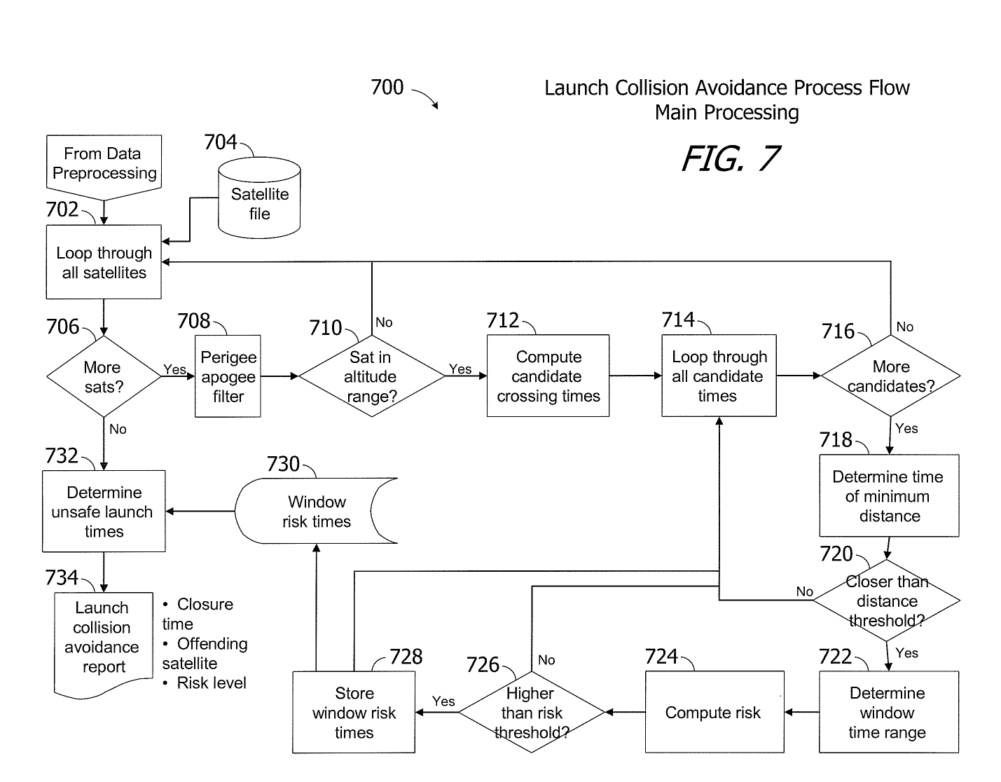

Referring to FIGS. 6 and 7, in an example embodiment, a launch collision avoidance process flow includes data preprocessing 600 and main processing 700.

With respect to the data preprocessing 600, inputs 602 are accessed by the computer 502 or other processor(s). By way of example, the inputs include (but are not limited to): launch window start time, launch window end time, risk threshold, distance threshold, file name of launch ephemeris, and file name of protected satellites. At 604, the launch ephemeris files 606 are read. At 608, rotation is made to the inertial coordinate system at launch window start time. At 610, the data preprocessing advances to the step of computing and storing launch ephemeris interpolating coefficients 612. Thereafter, at 614, the minimum and maximum ephemeris altitudes are determined. At 616, the plane of the launch ephemeris is determined. At 618, prior to advancing to the main processing, the geometrical parameters of the launch window are computed.

With respect to the main processing 700, the geometrical parameters of the launch window output by the data preprocessing 600 are accessed, along with data from the protected satellite file 704. At 702, the processing loops as shown through an analysis of all of the satellites in the protected satellite file 704. At 706, if it is determined that there are data (for additional satellites) that remains to be evaluated, the main processing 700 advances to the perigee apogee filter 708, which is applied to the satellite data. More specifically, the perigee apogee filter 708 compares a launch vehicle trajectory to the perigee and apogee of satellites to eliminate satellites from further analysis. If a determination is made, at 710, that the satellite is not within an altitude rage of concern, then the main processing 700 loops back to analyze the next satellite in the protected satellite file 704. If, however, the satellite is within an altitude rage of concern, then the main processing 700 advances, at 712, to computing candidate crossing times for intersections of the satellite passage windows and the launch vehicle passage windows. At 714 and 716, the main processing 700 loops through the process of examining all candidate times. At 718, the time of minimum distance between the launch vehicle and the satellite is determined. If it is determined, at 720, that the minimum distance is not closer than a distance threshold, then the main processing 700 returns to looping through the examination of candidate times. If the minimum distance is closer (i.e., less) than the distance threshold, then the processing advances to 722 where the time span for which the satellite and launch vehicle are within the distance threshold is determined. At 724, the collision probability is computed in conventional fashion. See, e.g., Chan, K., “Improved Analytical Expressions for Computing Spacecraft Collision Probabilities,” AAS Paper No. 03-184, AAS/AIAA Space Flight Mechanics Meeting, Ponce, Puerto Rico, 9-13 Feb. 2003, which is incorporated herein by reference in its entirety. At 726, if it is determined that the probability of collision is higher than a risk threshold, at 728, the window risk times 730 are stored. If it is determined that the probability of collision is not higher than the risk threshold, and after the window risk times are stored, the main processing 700 returns again to looping through the examination of candidate times. At 732, unsafe launch times are determined and used to generate a launch collision avoidance report 734, which includes information such as: closure time, offending satellite, and risk level.

In the following sections, details of an example embodiment of the data preprocessing 600 and main processing 700 are discussed.

### Launch Ephemeris Characterization

Given an ECF launch ephemeris, data preprocessing 600 begins by performing some preprocessing of the data. This preprocessing is valid for all resident satellites so it need be done only once. Let

\vec{r}_{ECF}=position in ECF coordinate system

\vec{v}_{ECF}=velocity in ECF coordinate system

be a point in the ephemeris file at time t relative to the start of the ephemeris file. The launch trajectory is provided in Earth fixed coordinates. It can be transformed into inertial coordinates using a rotation matrix so that

\vec{r}_{L}=Q\vec{r}_{ECF}

\vec{v}_{L}=Q\vec{v}_{ECF}+\dot{Q}\vec{r}_{ECF}

where the subscript L denotes the launch vehicle in an inertial coordinate system.

$$Q = ( \begin{matrix}cos θ & - sin θ & 0 \\ sin θ & cos θ & 0 \\ 0 & 0 & 1\end{matrix} )$$

$$\dot{Q} = \dot{θ} ( \begin{matrix}- sin θ & - cos θ & 0 \\ cos θ & - sin θ & 0 \\ 0 & 0 & 0\end{matrix} )$$

with

θ=Greenwich hour angle at time Tₛₜₐᵣₜ+t

\dot{θ}=rotation rate of the Earth

Next, cubic spline interpolating coefficients for the entire ephemeris file (or files) are determined. These interpolating coefficients are determined only once.

The data preprocessing 600 next examines every point in the ephemeris file and determines the largest and smallest radial distance achieved anywhere in the ephemeris. Let

r_{High}=largest radial distance in ephemeris

r_{Low}=smallest radial distance in ephemeris

The average plane of the ephemeris at the beginning of the launch window is then determined. Let

i_{Av}=average inclination of ephemeris

Ω_{Av}=average right ascension of ephemeris

σ_{Plane}=standard deviation of plane of ephemeris

Finally, the data is supplemented with interpolating coefficients for the true argument of latitude and radial distance of the ephemeris.

### Launch Wedge Characterization

As discussed above, the ephemeris foiins an approximate plane at the beginning of the launch window. During the course of the launch window, this plane rotates with the Earth to a final location at the end of the launch window. The beginning and ending planes can be characterized by the orientation angles

Ωₛₜₐᵣₜ=Ω_{Av}

iₛₜₐᵣₜ=i_{Av}

Ω_{end}=Ωₛₜₐᵣₜ+\dot{θ}(T_{end}−Tₛₜₐᵣₜ)

i_{end}=i_{Av}

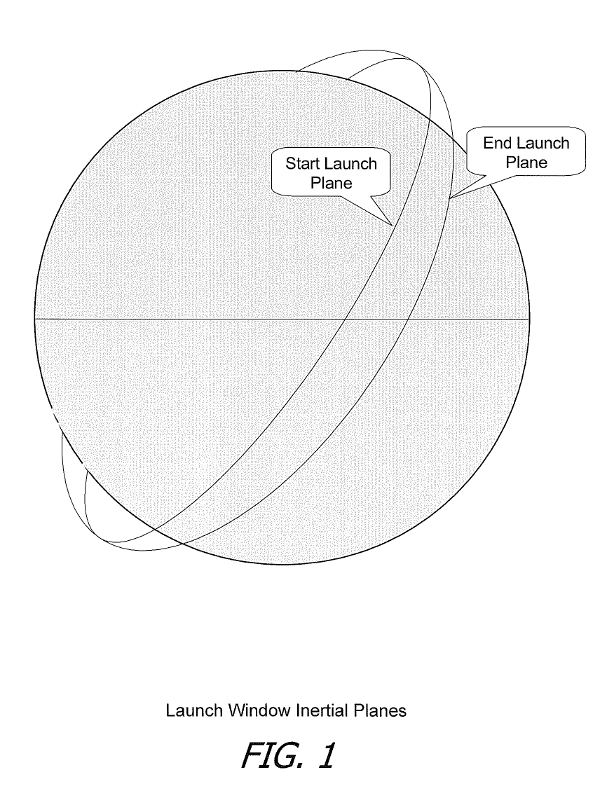

FIG. 1 illustrates what these two planes might look like for a launch window of a few hours in length. These two planes form two wedges much like two sections of an orange. Let

\vec{w}ₛₜₐᵣₜ=unit vector normal to the start inertial plane

\vec{w}_{end}=unit vector normal to the end inertial plane

The line of intersection of the two planes is given by the unit vector

$$\vec{k} = \frac{{\vec{w}}_{start} \times {\vec{w}}_{end}}{‖ {\vec{w}}_{start} \times {\vec{w}}_{end} ‖}$$

Because these wedges are formed by rotating the launch plane with the Earth, the left hand plane is the start time plane and the right hand plane is the end time plane. Therefore, the \vec{k} unit vector will point to the ascending side of the launch trajectories. The launch trajectories move along the planes until they reach the intersection point where the planes will cross. These two wedges shall be referred to as the ascending wedge and the descending wedge. Let

Δₛₜₐᵣₜ=angle from equator to \vec{k} measured in start plane

Δ_{end}=angle from equator to \vec{k} measured in end plane

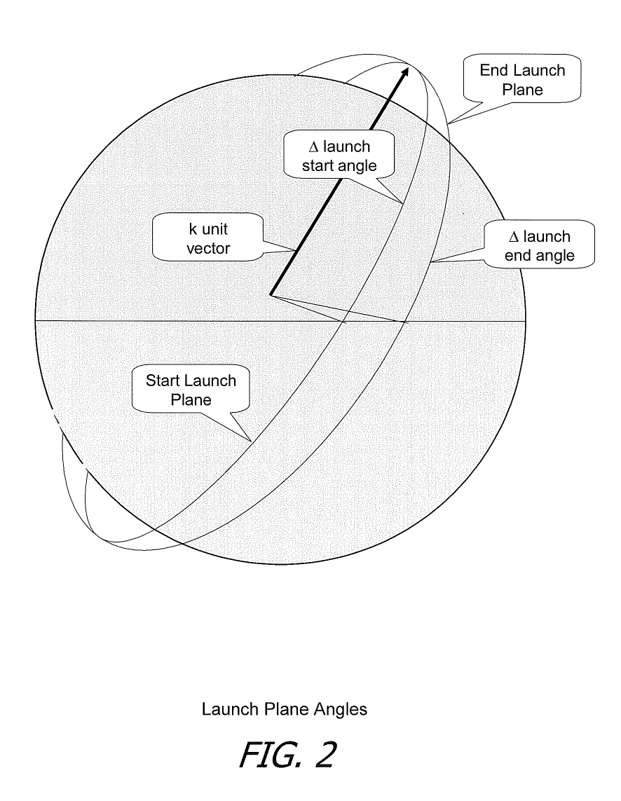

These two angles will be in the range [0,π] by construction. FIG. 2 illustrates these angles. An orbiting satellite is vulnerable to collision with the launch vehicle only during times in which it is within these wedges.

Up to this point all computations have been independent of the satellite orbit to be avoided. Thus, they need be done only once for the entire launch screening.

### Altitude Filter

The following is a discussion of a particular satellite being assessed for launch collision risk for the entire launch window. Launch windows are typically tens of minutes in length for near Earth satellites and a few hundred minutes in length for geosynchronous satellites. During such short time periods, a resident satellite orbit does not undergo significant perturbations. However, the satellite element set epoch may be a significant time away from the launch window time. Hence, the satellite is predicted to the midpoint time of the launch window. This provides updated mean orbital elements which can be assumed to not change significantly over a time interval of half the launch window span.

If the perigee of the satellite orbit is higher than the highest altitude of the launch trajectory, then the satellite does not need to be considered. That is, if

a(1−e)>r_{High}+D

then the satellite can be filtered from further consideration.

Likewise, if the apogee of the satellite is lower than the lowest altitude of the launch trajectory, then the satellite does not need to be considered. That is, if

a(1+e)+D<r_{Low}

then the satellite can be filtered from further consideration.

If an orbit has not been filtered by either of the altitude filters, then it is assumed that it may potentially intersect or come close to the launch trajectory for some launch time.

### Satellite Time Windows

A satellite is only vulnerable to collision with the launch vehicle during times in which the satellite is passing through the launch wedge. Such time periods shall be referred to as satellite time windows.

The following notation is now introduced for the mean orbital elements of the satellite predicted to the midpoint of the launch window.

n=mean motion

e=mean eccentricity

i=mean inclination

Ω=mean right ascension of ascending node

ω=mean argument of perigee

M=mean anomaly

The satellite epoch time, T₀ (real world time), is also introduced, where the subscript 0 convention indicates the value of a variable at the element set epoch time.

In order to determine the times in which the satellite is passing through the launch wedge, continue the development of a geometric model of the satellite-launch wedge relationship. The line of intersection of the satellite plane and the launch start plane is given by the vector

$${\vec{k}}_{start} = \frac{{\vec{w}}_{Sat} \times {\vec{w}}_{start}}{‖ {\vec{w}}_{Sat} \times {\vec{w}}_{start} ‖}$$

where

\vec{w}_{Sat}=unit normal to satellite plane at midpoint of launch window

Note that the previous equation is not defined when the satellite plane and the launch plane coincide. This is called the coplanar case and must be handled separately. It will be discussed in a later section.

Let

u_{Sat}_{_{—}}ₛₜₐᵣₜ=angle from equator to \vec{k}ₛₜₐᵣₜ measured in satellite plane

u_{launch}_{_{—}}ₛₜₐᵣₜ=angle from equator to \vec{k}ₛₜₐᵣₜ measured in launch start plane

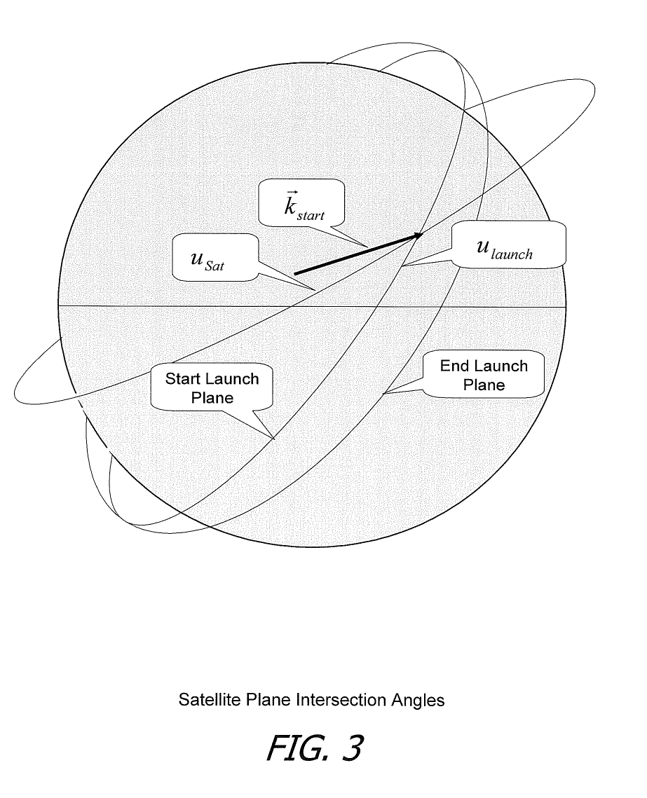

Then u_{Sat}_{_{—}}ₛₜₐᵣₜ is the satellite true argument of latitude at which the satellite enters the vulnerability wedge. FIG. 3 illustrates these angles.

Let

u₁=u_{Sat}_{_{—}}ₛₜₐᵣₜ

Similarly, the line of intersection of the satellite plane and the launch end plane is given by the vector

$${\vec{k}}_{end} = \frac{{\vec{w}}_{Sat} \times {\vec{w}}_{end}}{‖ {\vec{w}}_{Sat} \times {\vec{w}}_{end} ‖}$$

### Let

u_{Sat}_{_{—}}_{end}=angle from equator to \vec{k}_{end} measured in satellite plane

u_{launch}_{_{—}}_{end}=angle from equator to \vec{k}_{end} measured in launch end plane

The angle from the equator to the line of intersection with the end plane will be the true argument of latitude of the satellite when it exits the vulnerability band. Let

u₂=u_{Sat}_{_{—}}_{end}

Once the entry and exit true arguments of latitude are obtained, the other entry and exit can be computed by adding π.

In this way, two intervals are formed

[u₁,u₂] [u₃,u₄]

which are the satellite true argument of latitude intervals when the satellite is passing through the launch vulnerability wedges.

The launch wedge was formed by approximating the plane followed by the launch trajectory. A standard deviation of the launch plane approximation is also computed. This statistic can be used to extend the satellite angle windows to account for the launch wedge approximation with a 3 sigma level of confidence.

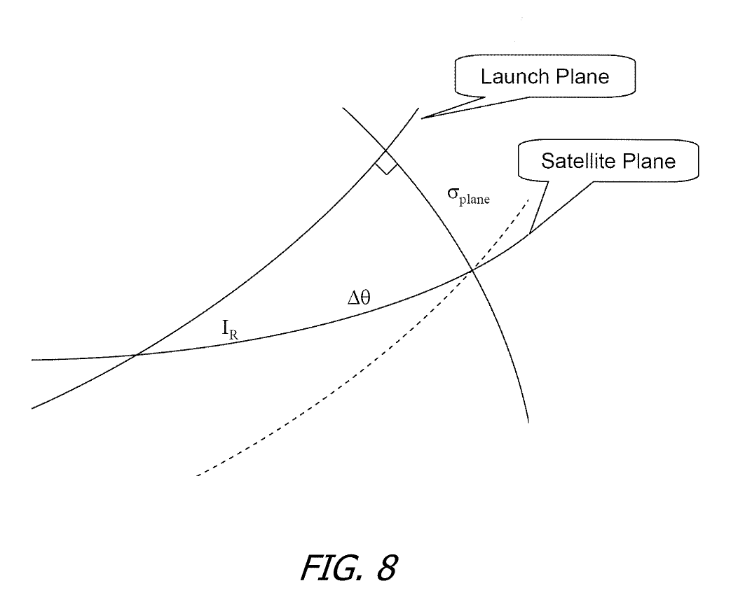

The launch trajectory will not usually be confined to an exact plane. However, it can be approximated by an average plane. The actual trajectory will vary about this average plane. This variation is quantified by the standard deviation of the launch plane. Referring to FIG. 8, let

σₚₗₐₙₑ=standard deviation of launch plane

I_{R}=relative inclination between launch and satellite planes

The dotted line represents the one-sigma noise in the launch orbital plane. Then

$$Δθ = \frac{{σ}_{plane}}{sin {I}_{R}}$$

is the amount of in-track expansion required for the satellite to reach the one-sigma plane noise.

This angle increment should be subtracted from the satellite entry angle and added to the satellite exit angle to produce an expanded satellite window that allows for the noise in the orbital plane. A three sigma value can be used to assure that the window is sufficiently expanded.

Thus, it has been demonstrated that

$$Δ u = 3 \frac{{σ}_{Plane}}{sin {I}_{R}}$$

so the expanded satellite angle windows become

u₁*=u₁−Δu

u₂*=u₂+Δu

u₃*=u₃−Δu

u₄*=u₄+Δu

The corresponding true anomalies, fⱼ, are found using

fⱼ=uⱼ*−ω

Then find the corresponding eccentric anomalies, Eⱼ, using

$${E}_{j} = 2 {tan}^{- 1} ( \sqrt{\frac{1 - e}{1 + e}} tan ( \frac{{f}_{j}}{2} ) )$$

The corresponding mean anomalies, Mⱼ, are given by

Mⱼ=Eⱼ−e sin Eⱼ

Then the times of flight from perigee passage to the desired latitude will be

$${t}_{j} = \frac{{M}_{j}}{n}$$

At this point, there are two time intervals

[t₁,t₂] [t₃,t₄]

during which the satellite is passing through the launch wedges.

By adding multiples of the satellite period, a series of time windows during which the satellite is in the launch wedge can be generated. But the in-track motion is affected by the geopotential through J₂ and the atmospheric drag through \dot{n}. So the period of the satellite continually changes due to atmospheric drag. However, being only interested in the time that it takes for one complete revolution, the period of the (i+1)th revolution in terms of the period of the ith revolution can be approximated as follows.

$${P}_{i + 1} = \frac{2 π}{{n}_{0} + {\dot{M}}_{0} + {\dot{n}}_{0} {P}_{i}}$$

where

$${\dot{M}}_{0} = - \frac{3}{4} \frac{{J}_{2} {R}^{2} {n}_{0} ( 1 - 3 {cos}^{2} {i}_{0} )}{{{a}_{0}^{2} ( 1 - {e}_{0}^{2} )}^{3 / 2}}$$

Then a series of latitude band passage time windows (relative time) is generated

$${t}_{1 i} = {t}_{perigee} + {t}_{1}^{*} + {\sum }_{j = 2}^{i} {P}_{j - 1}$$

$${t}_{2 i} = {t}_{perigee} + {t}_{2}^{*} + {\sum }_{j = 2}^{i} {P}_{j - 1}$$

$${t}_{3 i} = {t}_{perigee} + {t}_{3}^{*} + {\sum }_{j = 2}^{i} {P}_{j - 1}$$

$${t}_{4 i} = {t}_{perigee} + {t}_{4}^{*} + {\sum }_{j = 2}^{i} {P}_{j - 1}$$

where t_{perigee}=time relative to epoch of the most recent perigee passage prior to Tₛₜₐᵣₜ.

Thus, the time windows relative to epoch during which the satellite is flying through the launch vulnerability band are

[tᵢ₁,tᵢ₂] [tᵢ₃,tᵢ₄]

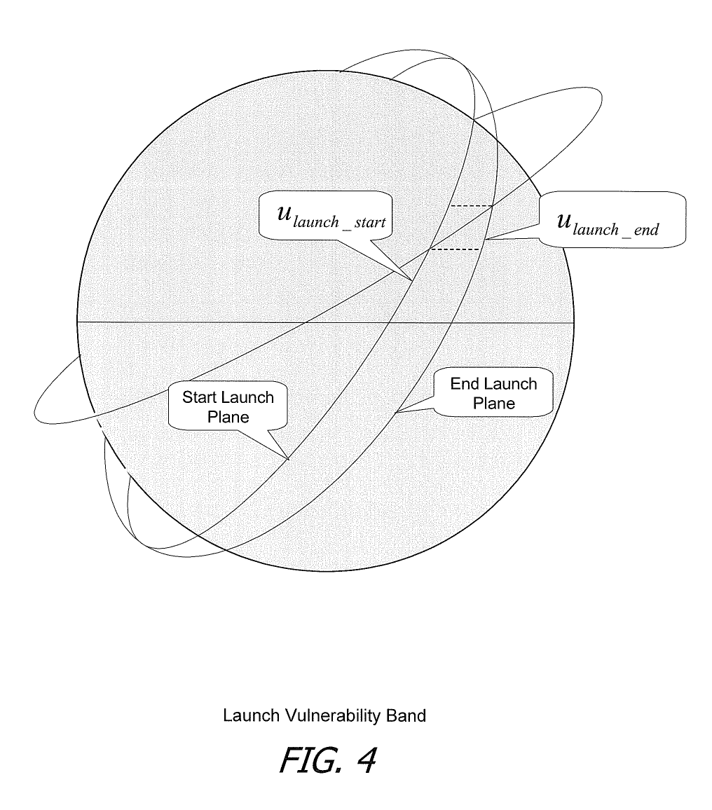

The intersection of the satellite orbit with the launch wedge creates a strip across the wedge, which shall be referred to as the launch vulnerability band. This is illustrated in FIG. 4.

The band begins when the launch vehicle reaches u_{launch}_{_{—}}ₛₜₐᵣₜ and ends when the launch vehicle reaches u_{launch}_{_{—}}_{end}. Because of the noise in the plane approximation, the entry and exit launch angles are modified as follows.

u_{launch}_{_{—}}ₛₜₐᵣₜ*=u_{launch}_{_{—}}ₛₜₐᵣₜ−Δu

u_{launch}_{_{—}}_{end}*=u_{launch}_{_{—}}_{end}−Δu

The earliest time that the launch vehicle could be at u_{launch}_{_{—}}ₛₜₐᵣₜ* will be

T_{entry}=Tₛₜₐᵣₜ+time of flight from launch to u_{launch}_{_{—}}ₛₜₐᵣₜ*

The latest time that the launch vehicle could be at u_{launch}_{_{—}}_{end}* will be

Tₑₓᵢₜ=T_{end}+time of flight from launch to u_{launch}_{_{—}}_{end}*

This results in a time window for the launch vehicle [T_{entry},Tₑₓᵢₜ] during which the launch vehicle could be in the launch vulnerability band.

Because the launch trajectory may extend for one complete revolution or more, there could be other times during which the launch vehicle could be in the launch vulnerability band on the other side of the orbit. That band is located at

u_{launch}_{_{—}}ₛₜₐᵣₜ*+π u_{launch}_{_{—}}_{end}*+π

This will produce a corresponding time window. In a similar way, a series of launch vulnerability time windows can be generated until the end of the launch ephemeris span is reached.

### Window Altitudes

For the time windows in which the satellite is passing through the launch wedge

[t₁,t₂] [t₃,t₄]

and the time windows during which the launch vehicle is crossing the path of the satellite

[T_{entry},Tₑₓᵢₜ],

the altitudes of the satellite and the launch vehicle as they traverse these windows can also be considered.

Let

R_{L-max}=maximum altitude of launch vehicle in crossing window

R_{L-min}=minimum altitude of launch vehicle in crossing window

r_{S-max}=maximum altitude of satellite in crossing window

r_{S-min}=minimum altitude of satellite in crossing window

Then if

R_{L-max}+D<r_{S-min}

or

R_{L-min}>r_{S-max}+D

the passage windows need not be considered.

### Time Candidates

The main processing 700 now looks for intersections of the satellite passage windows and the launch vehicle passage windows. For any intervals that intersect, a candidate time is created at the midpoint of the intersection.

Let tₛₐₜ be a candidate time relative to the satellite epoch. This is used as a starting point for an iterative search for the time of closest approach of the launch vehicle to the satellite.

The first estimate for the launch time, in this example, assumes that the minimum occurs at the midpoint of the launch ephemeris span. Thus, the first estimate is

t_{launch}=tₛₐₜ−t_{TOF}

where

$${t}_{TOF} = \frac{{T}_{entry} - {T}_{start} + {T}_{exit} - {T}_{end}}{2}$$

After the iteration has converged, a solution pair (t_{S},t_{L}) is yielded such that the distance between the launch vehicle and satellite is minimized.

### Distance Minimization

A function that gives the square of the distance between the launch vehicle and the satellite is now defined. Let where

D(t_{S},t_{L})=(\vec{r}_{S}−\vec{r}_{L})·(\vec{r}_{S}−\vec{r}_{L})

where

\vec{r}_{S}(t_{S})=position vector of satellite

\vec{r}_{L}(tₛ)=position vector of launch vehicle

where the function D depends on both the satellite prediction time t_{S} and the launch time t_{L}. Because t_{S} and t_{L} are independent variables, the distance function will reach a minimum or maximum when

$$\frac{\partial D}{\partial {t}_{S}} = 0$$

$$\frac{\partial D}{\partial {t}_{L}} = 0$$

The partial derivative constraint equations are solved simultaneously for the satellite prediction time and the launch time. They can be readily solved with an iterative technique starting from the very good first estimate from the previous discussion. This iteration produces the launch time and the satellite prediction time when the satellite and launch vehicle come closest. This time pair (tₛₐₜ,t_{Launch}) provides a point of departure for computing other metrics such as probability of collision.

### Analytic Partial Derivatives

As discussed above, the partial derivative constraint equations are to be solved simultaneously for the satellite prediction time and the launch time. By way of example, they can be solved using Newton's iterative method, given the very good first estimate (discussed supra). In particular, Newton's method gives

t_{S(i+1)}=t_{S(i)}+h

t_{L(i+1)}=t_{L(i)}+k

where

$$h = \frac{F \frac{\partial G}{\partial {t}_{L}} - G \frac{\partial F}{\partial {t}_{L}}}{\frac{\partial F}{\partial {t}_{L}} \frac{\partial G}{\partial {t}_{S}} - \frac{\partial F}{\partial {t}_{S}} \frac{\partial G}{\partial {t}_{L}}}$$

$$k = \frac{G \frac{\partial F}{\partial {t}_{S}} - F \frac{\partial G}{\partial {t}_{S}}}{\frac{\partial F}{\partial {t}_{L}} \frac{\partial G}{\partial {t}_{S}} - \frac{\partial F}{\partial {t}_{S}} \frac{\partial G}{\partial {t}_{L}}}$$

$$F = \frac{\partial D}{\partial {t}_{S}}$$

$$G = \frac{\partial D}{\partial {t}_{L}}$$

This iteration will give the launch time and the satellite prediction time when the satellite and launch vehicle come closest. This time pair (t_{S},t_{L}) provides a point of departure for computing other metrics such as probability of collision.

Now the partial derivatives are computed. First, consider the partial derivative with respect to t_{S} for which it is assumed that t_{L} is fixed.

$$F = \frac{\partial D}{\partial {t}_{S}} = 2 ( {\vec{r}}_{S} - {\vec{r}}_{L} ) \cdot ( {\vec{v}}_{S} - {\vec{v}}_{L} ) = 0$$

Now the partial derivative with respect to t_{L} is considered. Because the satellite position does not depend on the launch time,

$$G = \frac{\partial D}{\partial {t}_{L}} = 2 ( {\vec{r}}_{S} - {\vec{r}}_{L} ) \cdot ( \frac{\partial {\vec{r}}_{S}}{\partial {t}_{L}} - \frac{\partial {\vec{r}}_{L}}{\partial {t}_{L}} ) = - 2 ( {\vec{r}}_{S} - {\vec{r}}_{L} ) \cdot ( \frac{\partial {\vec{r}}_{L}}{\partial {t}_{L}} )$$

### Now,

$$\frac{\partial {{r}^{->}}_{L}}{\partial {t}_{L}}$$

is considered. The launch trajectory is provided in Earth fixed coordinates. The inertial position of the launch vehicle is given by

\vec{r}_{L}=M\vec{W}

where

$$M = ( \begin{matrix}cos Ω & - sin Ω cos i & sin Ω sin i \\ sin Ω & cos Ω cos i & - cos Ω sin i \\ 0 & sin i & cos i\end{matrix} )$$

$$\vec{W} = ( \begin{matrix}r sin u \\ r cos u \\ 0\end{matrix} )$$

The partial derivative will be

$$\frac{\partial {\vec{r}}_{L}}{\partial {t}_{L}} = M \frac{\partial \vec{W}}{\partial {t}_{L}} + \frac{\partial M}{\partial {t}_{L}} \vec{W}$$

The time of flight of the launch vehicle is defined as follows

t_{TOF}=t_{S}−t_{L}

A change in the launch time will cause an opposite change in the time of flight. This effect must also be included in the partial derivative. Note that the change in sign is due to the effect being in the opposite direction.

$$\frac{\partial \vec{W}}{\partial {t}_{L}} = - \frac{\partial \vec{W}}{\partial {t}_{TOF}}$$

### Thus,

$$\frac{\partial {\vec{r}}_{L}}{\partial {t}_{L}} = - {\vec{v}}_{L} + \frac{\partial M}{\partial {t}_{L}} \vec{W}$$

A change in the launch time will affect the plane orientation matrix M. Accordingly, the partial derivative of the matrix with respect to launch time is

$$\frac{\partial M}{\partial {t}_{L}} = {M}_{L} = \dot{θ} ( \begin{matrix}- sin Ω & - cos Ω cos i & cos Ω sin i \\ cos Ω & - sin Ω cos i & sin Ω sin i \\ 0 & 0 & 0\end{matrix} )$$

where \dot{θ} is the rotation rate of the Earth.

Thus, the total partial derivative is

$$\frac{\partial {\vec{r}}_{L}}{\partial {t}_{L}} = - {\vec{v}}_{L} + {M}_{L} \vec{W}$$

### Equivalently,

$$\frac{\partial {\vec{r}}_{L}}{\partial {t}_{L}} = - {\vec{v}}_{L} + {M}_{L} {M}^{T} M \vec{W} = - {\vec{v}}_{L} + {M}_{L} {M}^{T} {\vec{r}}_{L}$$

$${M}_{L} {M}^{T} = \dot{θ} ( \begin{matrix}- sin Ω & - cos Ω cos i & cos Ω sin i \\ cos Ω & - sin Ω cos i & sin Ω sin i \\ 0 & 0 & 0\end{matrix} ) ( \begin{matrix}cos Ω & sin Ω & 0 \\ - sin Ω cos i & cos Ω cos i & sin i \\ sin Ω sin i & - cos Ω sin i & cos i\end{matrix} )$$

$${M}_{L} {M}^{T} = \dot{θ} ( \begin{matrix}0 & - 1 & 0 \\ 1 & 0 & 0 \\ 0 & 0 & 0\end{matrix} )$$

$$N = {M}_{L} {M}^{T} = \dot{θ} ( \begin{matrix}0 & - 1 & 0 \\ 1 & 0 & 0 \\ 0 & 0 & 0\end{matrix} )$$

$$So$$

$$\frac{\partial D}{\partial {t}_{L}} = - 2 ( {\vec{r}}_{S} - {\vec{r}}_{L} ) \cdot ( - {\vec{v}}_{L} = N {\vec{r}}_{L} )$$

$$Then , finally$$

$$F = \frac{\partial D}{\partial {t}_{S}} = 2 ( {\vec{r}}_{S} - {\vec{r}}_{L} ) \cdot ( {\vec{v}}_{S} - {\vec{v}}_{L} )$$

$$G = \frac{\partial D}{\partial {t}_{L}} = - 2 ( {\vec{r}}_{S} - {\vec{r}}_{L} ) \cdot ( - {\vec{v}}_{L} + N {\vec{r}}_{L} )$$

$$Now$$

$$\frac{\partial F}{\partial {t}_{S}} = 2 ( {\vec{v}}_{S} - {\vec{v}}_{L} ) \cdot ( {\vec{v}}_{S} - {\vec{v}}_{L} ) + 2 ( {\vec{r}}_{S} - {\vec{r}}_{L} ) \cdot ( {\vec{a}}_{S} - {\vec{a}}_{L} )$$

$$\frac{\partial F}{\partial {t}_{L}} = - 2 \frac{\partial {\vec{r}}_{L}}{\partial {t}_{L}} \cdot ( {\vec{v}}_{S} - {\vec{v}}_{L} ) - 2 ( {\vec{r}}_{S} - {\vec{r}}_{L} ) \cdot \frac{\partial {\vec{v}}_{L}}{\partial {t}_{L}}$$

As the partial of the position vector has already been computed, the partial of the velocity vector is now considered.

\vec{v}=M\vec{U}+M\vec{V}

where

$$\vec{U} = ( \begin{matrix}\dot{r } sin u \\ \dot{r} cos u \\ 0\end{matrix} )$$

$$\vec{V} = ( \begin{matrix}r \dot{f} cos u \\ - r \dot{f} sin u \\ 0\end{matrix} )$$

$$Then$$

$$\frac{\partial \vec{v}}{\partial {t}_{L}} = M \frac{\partial \vec{U}}{\partial {t}_{L}} + M \frac{\partial \vec{V}}{\partial {t}_{L}} + \frac{\partial M}{\partial {t}_{L}} \vec{U} + \frac{\partial M}{\partial {t}_{L}} \vec{V}$$

$$Rearranging gives$$

$$\frac{\partial \vec{v}}{\partial {t}_{L}} = M ( \frac{\partial \vec{U}}{\partial {t}_{L}} + \frac{\partial \vec{V}}{\partial {t}_{L}} ) + \frac{\partial M}{\partial {t}_{L}} \vec{U} + \frac{\partial M}{\partial {t}_{L}} \vec{V}$$

$$\frac{\partial \vec{v}}{\partial {t}_{L}} = - {\vec{a}}_{L} + {M}_{L} \vec{U} + {M}_{L} \vec{V}$$

$$Then$$

$$\frac{\partial F}{\partial {t}_{L}} = - 2 \frac{\partial {\vec{r}}_{L}}{\partial {t}_{L}} \cdot ( {\vec{v}}_{S} - {\vec{v}}_{L} ) - 2 ( {\vec{r}}_{S} - {\vec{r}}_{L} ) \cdot \frac{\partial {\vec{v}}_{L}}{\partial {t}_{L}}$$

$$\frac{\partial F}{\partial {t}_{L}} = - 2 ( {\vec{v}}_{S} - {\vec{v}}_{L} ) \cdot ( - {\vec{v}}_{L} + N {\vec{r}}_{L} ) - 2 ( {\vec{r}}_{S} - {\vec{r}}_{L} ) \cdot ( - {\vec{a}}_{L} + {M}_{L} \vec{U} + {M}_{L} \vec{V} )$$

$$G = \frac{\partial D}{\partial {t}_{L}} = - 2 ( {\vec{r}}_{S} - {\vec{r}}_{L} ) \cdot ( - {\vec{v}}_{L} + N {\vec{r}}_{L} )$$

$$\frac{\partial G}{\partial {t}_{S}} = - 2 ( {\vec{v}}_{S} - {\vec{v}}_{L} ) \cdot ( - {\vec{v}}_{L} + N {\vec{r}}_{L} ) - 2 ( {\vec{r}}_{S} - {\vec{r}}_{L} ) \cdot ( - {\vec{a}}_{L} + N {\vec{v}}_{L} )$$

$$\frac{\partial G}{\partial {t}_{L}} = 2 \frac{\partial {\vec{r}}_{L}}{\partial {t}_{L}} \cdot ( - {\vec{v}}_{L} + N {\vec{r}}_{L} ) - 2 ( {\vec{r}}_{S} - {\vec{r}}_{L} ) \cdot ( - \frac{\partial {\vec{v}}_{L}}{\partial {t}_{L}} + N \frac{\partial {\vec{r}}_{L}}{\partial {t}_{L}} )$$

$$\frac{\partial G}{\partial {t}_{L}} = 2 ( - {\vec{v}}_{L} + N {\vec{r}}_{L} ) \cdot ( - {\vec{v}}_{L} + N {\vec{r}}_{L} ) - 2 ( {\vec{r}}_{S} - {\vec{r}}_{L} ) \cdot ( - ( - {\vec{a}}_{L} + {M}_{L} \vec{U} + {M}_{L} \vec{V} ) + N ( - {\vec{v}}_{L} + N {\vec{r}}_{L} ) )$$

$$\frac{\partial G}{\partial {t}_{L}} = 2 ( - {\vec{v}}_{L} + N {\vec{r}}_{L} ) \cdot ( - {\vec{v}}_{L} + N {\vec{r}}_{L} ) + 2 ( {\vec{r}}_{S} - {\vec{r}}_{L} ) \cdot ( - {\vec{a}}_{L} + {M}_{L} \vec{U} + {M}_{L} \vec{V} + N {\vec{v}}_{L} - NN {\vec{r}}_{L} )$$

$$In summary$$

$$F = 2 ( {\vec{r}}_{S} - {\vec{r}}_{L} ) \cdot ( {\vec{v}}_{S} - {\vec{v}}_{L} )$$

$$G = - 2 ( {\vec{r}}_{S} - {\vec{r}}_{L} ) \cdot ( - {\vec{v}}_{L} + N {\vec{r}}_{L} )$$

$$\frac{\partial F}{\partial {t}_{S}} = 2 ( {\vec{v}}_{S} - {\vec{v}}_{L} ) \cdot ( {\vec{v}}_{S} - {\vec{v}}_{L} ) + 2 ( {\vec{r}}_{S} - {\vec{r}}_{L} ) \cdot ( - {\vec{a}}_{L} + {M}_{L} \vec{U} + {M}_{L} \vec{V} )$$

$$\frac{\partial G}{\partial {t}_{S}} = - 2 ( {\vec{v}}_{S} - {\vec{v}}_{L} ) \cdot ( - {\vec{v}}_{L} + N {\vec{r}}_{L} ) - 2 ( {\vec{r}}_{S} - {\vec{r}}_{L} ) \cdot ( - {\vec{a}}_{L} + N {\vec{v}}_{L} )$$

$$\frac{\partial G}{\partial {t}_{L}} = 2 ( - {\vec{v}}_{L} + N {\vec{r}}_{L} ) \cdot ( - {\vec{v}}_{L} + N {\vec{r}}_{L} ) + 2 ( {\vec{r}}_{S} - {\vec{r}}_{L} ) \cdot ( - {\vec{a}}_{L} + {M}_{L} \vec{U} + {M}_{L} \vec{V} + N {\vec{v}}_{L} - NN {\vec{r}}_{L} )$$

$$where$$

$${M}_{L} = \dot{θ} ( \begin{matrix}- sin Ω & - cos Ω cos i & cos Ω sin i \\ cos Ω & - sin Ω cos i & sin Ω sin i \\ 0 & 0 & 0\end{matrix} )$$

$$N = \dot{θ} ( \begin{matrix}0 & - 1 & 0 \\ 1 & 0 & 0 \\ 0 & 0 & 0\end{matrix} )$$

$$Because$$

$$F = \frac{\partial D}{\partial {t}_{S}}$$

$$G = \frac{\partial D}{\partial {t}_{L}}$$

$$then it follows that$$

$$\frac{\partial F}{\partial {t}_{L}} = \frac{{\partial }^{2} D}{\partial {t}_{L} \partial {t}_{S}} = \frac{\partial G}{\partial {t}_{S}}$$

$$In comparing$$

$$\frac{\partial F}{\partial {t}_{L}} = - 2 ( {\vec{v}}_{S} - {\vec{v}}_{L} ) \cdot ( - {\vec{v}}_{L} + N {\vec{r}}_{L} ) - 2 ( {\vec{r}}_{S} - {\vec{r}}_{L} ) \cdot ( - {\vec{a}}_{L} + {M}_{L} \vec{U} + {M}_{L} \vec{V} )$$

$$and$$

$$\frac{\partial G}{\partial {t}_{S}} = - 2 ( {\vec{v}}_{S} - {\vec{v}}_{L} ) \cdot ( - {\vec{v}}_{L} = N {\vec{r}}_{L} ) - 2 ( {\vec{r}}_{S} - {\vec{r}}_{L} ) \cdot ( - {\vec{a}}_{L} + N {\vec{v}}_{L} )$$

$$it is necessary to show that$$

$${M}_{L} \vec{U} + {M}_{L} \vec{V} = N {\vec{v}}_{L}$$

$$Now$$

$$\vec{v} = M \vec{U} + M \vec{V}$$

$$and$$

$$N = {M}_{L} {M}^{T}$$

$$so$$

$$N \vec{v} = {M}_{L} {M}^{T} M \vec{U} + {M}_{L} {M}^{T} M \vec{V}$$

$$N \vec{v} = {M}_{L} \vec{U} + {M}_{L} \vec{V}$$

Thus, the mixed second partials agree as they should.

Hence, the results are summarized as follows

F=2(\vec{r}_{S}−\vec{r}_{L})·(\vec{v}_{S}−\vec{v}_{L})

G=−2(\vec{r}_{S}−\vec{r}_{L})·(−\vec{v}_{L}+N\vec{r}_{L})

$$\frac{\partial F}{\partial {t}_{S}} = 2 ( {\vec{v}}_{S} - {\vec{v}}_{L} ) \cdot ( {\vec{v}}_{S} - {\vec{v}}_{L} ) + 2 ( {\vec{r}}_{S} - {\vec{r}}_{L} ) \cdot ( {\vec{a}}_{S} - {\vec{a}}_{L} )$$

$$\frac{\partial F}{\partial {t}_{L}} = \frac{\partial G}{\partial {t}_{S}} - 2 ( {\vec{v}}_{S} - {\vec{v}}_{L} ) \cdot ( - {\vec{v}}_{L} + N {\vec{r}}_{L} ) - 2 ( {\vec{r}}_{S} - {\vec{r}}_{L} ) \cdot ( - {\vec{a}}_{L} + N {\vec{v}}_{L} )$$

$$\frac{\partial G}{\partial {t}_{L}} = 2 ( - {\vec{v}}_{L} + N {\vec{r}}_{L} ) \cdot ( - {\vec{v}}_{L} + N {\vec{r}}_{L} ) + 2 ( {\vec{r}}_{S} - {\vec{r}}_{L} ) \cdot ( - {\vec{a}}_{L} + 2 N {\vec{v}}_{L} - NN {\vec{r}}_{L} )$$

$$Now$$

$$NN = {\dot{θ}}^{2} ( \begin{matrix}0 & - 1 & 0 \\ 1 & 0 & 0 \\ 0 & 0 & 0\end{matrix} ) ( \begin{matrix}0 & - 1 & 0 \\ 1 & 0 & 0 \\ 0 & 0 & 0\end{matrix} ) = - {\dot{θ}}^{2} ( \begin{matrix}1 & 0 & 0 \\ 0 & 1 & 0 \\ 0 & 0 & 0\end{matrix} )$$

### Coplanar Case

Recall that the first step in determining the satellite crossing times of the launch wedge utilized the following equation.

$${\vec{k}}_{start} = \frac{{\vec{w}}_{Sat} \times {\vec{w}}_{start}}{‖ {\vec{w}}_{Sat} \times {\vec{w}}_{start} ‖}$$

If the satellite plane and the launch plane coincide, then the equation is not defined. In fact, because the planes coincide, the satellite is always in the launch wedge. Launch trajectories exist for all times within the launch wedge. So even if the satellite plane does not coincide with the launch plane at the start of the launch wedge, it might correspond with the launch plane at a later time in the launch window. Thus, a different methodology is needed for any satellites whose orbital planes are coplanar with the launch plane at any time during the launch window. Practically speaking, any satellites whose orbital planes are close to the launch plane at any time during the launch window are also treated separately.

In an example embodiment, the following test is employed. If

\vec{w}_{Sat}·\vec{w}ₛₜₐᵣₜ>0.95

or

\vec{w}_{Sat}·\vec{w}_{end}>0.95

then the satellite is considered coplanar.

In a launch collision avoidance methodology for the coplanar case, discrete launch times (e.g., at a resolution of one second) are considered. Let

D(t_{S})=(\vec{r}_{S}−\vec{r}_{L})·(\vec{r}_{S}−\vec{r}_{L})

Then

\dot{D}(t_{S})=2(\vec{r}_{S}−\vec{r}_{L})·(\vec{v}_{S}−\vec{v}_{L})

For a given discrete launch time, the coplanar approach steps along the orbit in time searching for a change in sign of \dot{D} from negative to positive. Such a change indicates the distance function has passed through a minimum and is recorded as a time candidate for further investigation. The step size can be large (e.g., 20% of satellite period) because the function is smooth. In an example embodiment, one fifth of the smaller of the satellite and launch vehicle orbital periods is used. A root-finding algorithm, such as Brent's method, can be used to refine the candidate and determine the time at which the satellite and launch vehicle come closest for a fixed discrete launch time. This result will be within one second of the true minimum because, in this example, fixed launch times at one second spacing were considered. With this starting time pair (t_{S},t_{L}), the two variable minimization technique previously described can now be used to find the exact two variable minimum.

Although the present invention has been described in terms of the example embodiments above, numerous modifications and/or additions to the above-described embodiments would be readily apparent to one skilled in the art. It is intended that the scope of the present invention extend to all such modifications and/or additions.

What is claimed is:

1. An analytic launch collision avoidance method, comprising the step of:
providing a launch collision avoidance report generated by evaluating launch times for a launch vehicle and candidate satellite crossing times for a plurality of satellites based on a geometric formulation in terms of two time variables.

2. The analytic launch collision avoidance method of claim 1, further comprising the step of:
initiating or canceling a launch event depending upon the launch collision avoidance report.

3. The analytic launch collision avoidance method of claim 1, wherein evaluating the launch times and the candidate satellite crossing times includes refining a pair of times for which the launch vehicle and a satellite come closest together.

4. The analytic launch collision avoidance method of claim 3, wherein the pair of times is a launch time for the launch vehicle and a real world time when the satellite and the launch vehicle come closest together.

5. The analytic launch collision avoidance method of claim 3, wherein generating the pair of times includes computing corrections to the pair of times using an iterative technique.

6. The analytic launch collision avoidance method of claim 3, wherein generating the pair of times includes computing corrections to the pair of times using a two variable minimization technique.

7. The analytic launch collision avoidance method of claim 3, wherein generating the pair of times includes computing corrections to the pair of times using Newton's method.

8. The analytic launch collision avoidance method of claim 3, further comprising the step of:
generating a starting time pair, as initial inputs for the process of refining the pair of times, depending upon changes in sign of a distance function along an orbit.

9. The analytic launch collision avoidance method of claim 8, wherein generating a starting time pair includes utilizing a root-finding algorithm to refine a candidate starting time pair and determine the time at which the satellite and the launch vehicle come closest for a fixed discrete launch time.

10. The analytic launch collision avoidance method of claim 9, wherein the root-finding algorithm is Brent's method.

11. The analytic launch collision avoidance method of claim 3, wherein providing a launch collision avoidance report includes comparing a minimum distance associated with the pair of times to a distance threshold to determine whether a candidate launch time should be rejected.

12. The analytic launch collision avoidance method of claim 3, wherein providing a launch collision avoidance report includes using the pair of times to determine a collision probability.

13. The analytic launch collision avoidance method of claim 1, wherein evaluating the launch times and the candidate satellite crossing times includes comparing a launch vehicle trajectory to the perigee and apogee of satellites to eliminate satellites from further analysis.

14. The analytic launch collision avoidance method of claim 1, wherein evaluating the launch times and the candidate satellite crossing times includes applying an altitude filter to an orbit associated with a candidate satellite crossing time.

15. The analytic launch collision avoidance method of claim 1, wherein evaluating the launch times and the candidate satellite crossing times includes determining a satellite time window during which a satellite passes through a launch wedge.

16. The analytic launch collision avoidance method of claim 15, wherein the launch wedge is formed by approximating a plane followed by the trajectory of the launch vehicle.

17. The analytic launch collision avoidance method of claim 1, wherein evaluating the launch times and the candidate satellite crossing times includes determining a launch vulnerability band across a launch wedge from an intersection of a satellite orbit with the launch wedge.

18. An analytic launch collision avoidance method, comprising the steps of:
evaluating launch times for a launch vehicle and candidate satellite crossing times for a plurality of satellites using completely analytic partial derivatives to determine unsafe launch times; and
initiating or canceling a launch event depending upon the unsafe launch times.

19. The analytic launch collision avoidance method of claim 18, wherein evaluating the launch times and the candidate satellite crossing times includes generating a pair of times for which the launch vehicle and a satellite come closest together.

20. The analytic launch collision avoidance method of claim 19, wherein the pair of times is a launch time for the launch vehicle and a real world time when the satellite and the launch vehicle come closest together.

21. The analytic launch collision avoidance method of claim 19, wherein generating the pair of times includes computing corrections to the pair of times using an iterative technique.

22. The analytic launch collision avoidance method of claim 19, wherein generating the pair of times includes computing corrections to the pair of times using a two variable minimization technique.

23. The analytic launch collision avoidance method of claim 19, wherein generating the pair of times includes computing corrections to the pair of times using Newton's method.

24. The analytic launch collision avoidance method of claim 19, further comprising the step of:
generating a starting time pair, as initial inputs for the process of generating the pair of times, depending upon changes in sign of a distance function along an orbit.

25. The analytic launch collision avoidance method of claim 24, wherein generating a starting time pair includes utilizing a root-finding algorithm to refine a candidate starting time pair and determine the time at which the satellite and the launch vehicle come closest for a fixed discrete launch time.

26. The analytic launch collision avoidance method of claim 25, wherein the root-finding algorithm is Brent's method.

27. The analytic launch collision avoidance method of claim 19, wherein evaluating the launch times and the candidate satellite crossing times includes comparing a minimum distance associated with the pair of times to a distance threshold to determine whether a candidate launch time should be rejected.

28. The analytic launch collision avoidance method of claim 19, wherein evaluating the launch times and the candidate satellite crossing times includes using the pair of times to determine a collision probability.

29. The analytic launch collision avoidance method of claim 18, wherein evaluating the launch times and the candidate satellite crossing times includes comparing a launch vehicle trajectory to the perigee and apogee of satellites to eliminate satellites from further analysis.

30. The analytic launch collision avoidance method of claim 18, wherein evaluating the launch times and the candidate satellite crossing times includes applying an altitude filter to an orbit associated with a candidate satellite crossing time.

31. The analytic launch collision avoidance method of claim 18, wherein evaluating the launch times and the candidate satellite crossing times includes determining a satellite time window during which a satellite passes through a launch wedge.

32. The analytic launch collision avoidance method of claim 31, wherein the launch wedge is formed by approximating a plane followed by the trajectory of the launch vehicle.

33. The analytic launch collision avoidance method of claim 18, wherein evaluating the launch times and the candidate satellite crossing times includes determining a launch vulnerability band across a launch wedge from an intersection of a satellite orbit with the launch wedge.
